(19) United States
(12) Patent Application Publication
(10) Pub. No.: US 2026/0203399 A1
(43) Pub. Date: Jul. 16, 2026

(54) SYSTEM AND METHOD FOR DETECTING THREAT FACTORS BY COMPARING/ ANALYZING INSTALLATION FILES ON BASIS OF SBOM FROM CONSUMER'S PERSPECTIVE

(71) Applicant: REDPENSOFT CO., LTD., Gyeonggi-do (KR)

(72) Inventor: Changjin CHOI, Seoul (KR)

(21) Appl. No.: 19/136,976

(22) PCT Filed: Nov. 10, 2023
(86) PCT No.: PCT/KR2023/018033

§ 371 Date: Jun. 9, 2025

(30) Foreign Application Priority Data
Dec. 8, 2022 (KR) 10-2022-0170270

(51) Int. Cl. G06F 21/56; G06F 8/61

(52) U.S. Cl. CPC G06F 21/56; G06F 8/61

(57) ABSTRACT

A system for detecting threat factors by comparing/analyzing installation files on the basis of SBOMs from a consumer's perspective, the system including: a reference information DB configured to store Software Bill of Materials (SBOM) information, regarding the types of API functions for the execution of an installation file installed on a client terminal and parameters of each API function at the time when the corresponding API function is called, as previous component information, and to store SBOM information, regarding the types of API functions for the execution of a checking target installation file and parameters of each API function at the time when the corresponding API function is called, as subsequent component information; a component decomposition module configured to extract components of an installation file input to the client terminal; an API information extraction module; and a comparison/analysis module.

### TECHNICAL FIELD

The present invention relates to a system and method for detecting threat factors by comparing/analyzing installation files on the basis of SBOMs from a consumer's perspective, which may determine whether malware is present by analyzing a patch file of software.

### BACKGROUND ART

Software providers provide patch files to ensure that software is operated stably when software functions are added, changed, or removed. However, with the advent of the IoT environment, various types of unverified files are being distributed indiscriminately over networks, and there are cases where tampered files are distributed even from reliable servers. For example, during the recent North American summit, malware disguised as a related information file was distributed, and recently, malware has been distributed in large quantities via Torrent.

When update services or security patches are provided by large providers such as Microsoft, Adobe and Hancom, general users access and download the providers'patch files. However, recently, attackers have been able to indirectly attack all customers who receive software by infiltrating software providers and inserting malware into distributed patch files. In this case, it is impossible to detect the threats posed by malware in advance by using only a conventional method of checking whether a patch file is malware, and eventually, it causes significant damage to a plurality of users to whom the patch file is distributed.

These types of malware exploit not only new, unknown vulnerabilities called zero-day vulnerabilities, but also previously patched vulnerabilities. In particular, in the case of companies, when a patch file infected with malware is distributed to all clients within a company over an internal network, massive damage may occur.

Therefore, there is an urgent demand for security technology that can determine whether a patch file is infected with malware in advance by precisely analyzing the patch file itself.

### SUMMARY OF THE INVENTION

Accordingly, the present invention has been conceived to overcome the above-described problems, and an object of the present invention is to provide a system and method for detecting threat factors by comparing/analyzing installation files on the basis of SBOMs from a consumer's perspective, which detect malware hidden in a patch file of software from a user's perspective and enable countermeasures to be taken for data security.

### Technical Solution

In order to accomplish the above object, the present invention provides a system for detecting threat factors by comparing/analyzing installation files on the basis of SBOMs from a consumer's perspective, the system including:
a reference information DB configured to store Software Bill of Materials (SBOM) information, regarding the types of API functions for the execution of an installation file installed on a client terminal and parameters of each API function at the time when the corresponding API function is called, as previous component information, and to store SBOM information, regarding the types of API functions for the execution of a checking target installation file and parameters of each API function at the time when the corresponding API function is called, as subsequent component information;
a component decomposition module configured to extract components of an installation file input to the client terminal;
an API information extraction module configured to identify API functions for the SBOM extraction of the components, to identify a monitoring target API function called when malware is executed by setting a state value for the API functions, to extract a code block of the monitoring target API function through operation in conjunction with a disassembler, to back-track code call information for the code block of the monitoring target API function to identify parameters at the time when the API function is called, and to generate SBOM information regarding the type of API function for which the above parameters have been identified and the parameters as subsequent component information and store it in the reference information DB; and
a comparison/analysis module configured to check whether the subsequent component information generated by the API information extraction module and the previous component information of the corresponding API function match each other by comparing them.

### Advantageous Effects

The above-described present invention decomposes normal and new patch files of software into API functions and compares them, so that it is possible to determine the presence of malware by checking whether there is a change in the file format or a risky behavior such as a new API function call, thereby preventing the installation of a dangerous patch file during a patching process for target software.

### BRIEF DESCRIPTION OF DRAWINGS

FIG. 1 is a block diagram showing the configuration of a detection system according to the present invention;

FIG. 2 is a flowchart showing a detection method executed on the basis of the detection system according to the present invention;

FIG. 3 is a flowchart specifically illustrating the component extraction step shown in FIG. 2;

FIG. 4 is a flowchart specifically illustrating the component analysis step shown in FIG. 2;

FIG. 5 is a flowchart specifically illustrating the parameter extraction analysis step shown in FIG. 2; and

FIG. 6 is a flowchart specifically illustrating the parameter comparison step shown in FIG. 2.

### DETAILED DESCRIPTION OF THE INVENTION

Details of the present invention will be described in detail below with reference to the accompanying drawings.

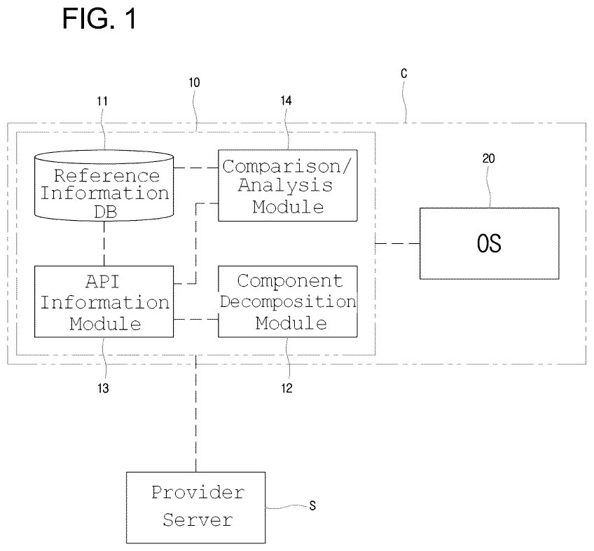

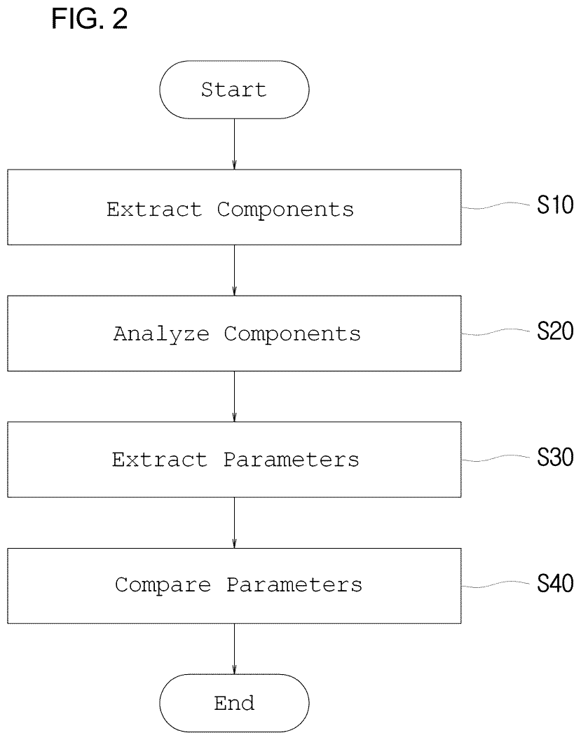

FIG. 1 is a block diagram showing the configuration of a detection system according to the present invention, and FIG. 2 is a flowchart showing a detection method executed on the basis of the detection system according to the present invention.

Referring to FIGS. 1 and 2, a detection system 10 according to the present invention includes a reference information DB 11, a component decomposition module 12, an API information extraction module 13, and a comparison/analysis module 14 that are operated on the basis of the Operating System (OS) of a client terminal C.

The reference information DB 11 stores Software Bill of Materials (SBOM) information, regarding the types of API functions for the execution of an existing patch file installed on the client terminal C and the parameters (the call arguments) of each API function at the time when the corresponding API function is called, as previous component information, and also stores SBOM information, regarding the types of API functions for the execution of a checking target patch file and the parameters of each API function at the time when the corresponding API function is called, as subsequent component information. Furthermore, the previous component information and the subsequent component information may each include the number of calls for each API function. The previous component information is utilized as reference information for determining whether the subsequent component information identified in a new patch file is malicious. Meanwhile, the detection system 10 according to the present invention may designate all patch files of software as checking targets, or may designate only patch files suspected of being threats as checking targets. For reference, in the present embodiment, the previous component information is separated and stored for each piece of software. In the description of the present invention, the patch file is an embodiment of an installation file installed on the terminal C, and the installation file may be a program that performs a specific function while operating in conjunction with the OS 20 of the terminal C. In the present embodiment, the installation file is described using the patch file as an example, but the installation file is not limited thereto. In the attached claims, this is named and claimed as an installation file, which is a representative name that can encompass one program.

The component decomposition module 12 decomposes the patch file, input to the client terminal C, into components for the purpose of updating specific software. To this end, the component decomposition module 12 extracts components through an installer or compressed file decompression, and also extracts all installation components through sandbox execution or the like.

In order to check whether the patch file is infected with malware, the API information extraction module 13 identifies an API function for SBOM extraction in an execution component of the components obtained by the decomposition, and extracts parameters. In order to extract and identify the parameters of the API function, the API information extraction module 13 additionally sets a state value for API functions, extracts an API function called when malware is executed, and designates the corresponding API function as a monitoring target API function. Furthermore, the overall code block of the monitoring target API function is first extracted. In the present embodiment, the code block extraction is performed using disassembler software such as Interactive DisAssembler (IDA), GHIDRA or the like. For reference, the disassembler generates assembly source code from machine code, and supports various types of operating systems and executable files. The code block refers to machine code composed of a combination of binary numbers.

Thereafter, the API information extraction module 13 back-tracks the code call information of the code block to determine the parameters at the time when a caller actually calls the API function, and records information about the parameters in an analysis report (subsequent component information). In the present embodiment, the back-tracking of the code call information uses an extended script engine (IDA-PYTHON) provided by the disassembler such as IDA, GHIDRA, or the like. For reference, the extended script engine controls metadata such as code blocks, variables, and IDA state values provided by IDA in the PYTHON language.

The API information extraction module 13 repeatedly extracts parameters until there is no code block of the monitoring target API function, generates information about the type and parameters of the monitoring target API function as subsequent component information, and stores it in the reference information DB.

The comparison/analysis module 14 compares the previous component information stored in the reference information DB 11 with the subsequent component information recorded as the analysis report by the API information extraction module 13 to check whether there are changes, and stores changed portions as change values. When items suspected of being dangerous are found among the differences or changes between the previous component information and the subsequent component information, information about them is recorded as result values.

A method of detecting threat factors on the basis of the detection system 10 according to the present invention will be described.

FIG. 2 is a flowchart showing a detection method executed on the basis of a detection system according to the present invention.

Referring to FIGS. 1 and 2, the detection method according to the present invention includes a component extraction step S10 of decomposing a patch file into components and extracting the components, a component analysis step S20 of identifying an API function for the SBOM extraction of the extracted components, a parameter extraction step S30 of extracting parameters from the API function of each of all the components extracted from the patch file or each component suspected of having malware, and a parameter comparison step S40 of comparing the extracted parameters with reference information (previous component information) to check whether there are changes. In this case, the parameter comparison step S40 may further include the step of transmitting changes in the subsequent component information based on the reference information to the provided server S of the corresponding patch file and identifying them.

The detection system 10 and detection method of the present invention extract the SBOM (Software Bill of Materials) of the previous component information for a previous patch file installed on the client terminal C of a user corresponding to the consumer of an application, and, when the installation of the checking target patch file is attempted on the client terminal C, extract and compare the SBOM of the subsequent component information for the checking target patch file, thereby enabling active metadata comparison from the perspective of the consumer (the user). In other words, the consumer (the user) does not rely solely on the provider's determination of whether the patch file is dangerous, but proactively determines whether the patch file is abnormal, thereby preventing the infection of the client terminal C in advance.

In addition, the detection system 10 and detection method of the present invention communicate with the provider server S through a communication medium such as a cloud, so that the user (the consumer) can directly participate and communicate in the decision-making of software developers and operating personnel regarding the presence of abnormalities in patch files in the provider server S of a Software Development Life Cycle (SDLC) environment that performs an SBOM function.

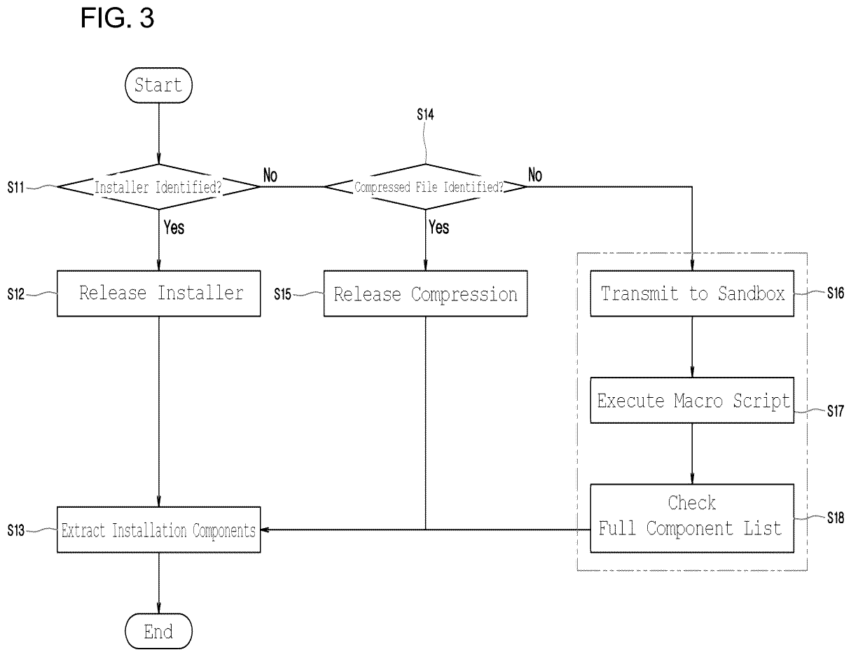

FIG. 3 is a flowchart specifically illustrating the component extraction step shown in FIG. 2.

Referring to FIGS. 1 to 3, the component extraction step S10 in the detection method according to the present invention includes an installer identification step S11, an installer release step S12, an installation component extraction step S13, a compressed file identification step S14, a compressed file release step S15, a transfer-to-sandbox step S16, a macro script execution step S17, and a full component list checking step S18.

More specifically, as for the component extraction step S10, the component decomposition module 12 of the detection system 10 detects an installer in a patch file received from the provider server S in step S11. When the installer of the patch file is identified as a result of the detection, the installer is released in step S12, and information about all components for the client terminal C is extracted in step S13. In this case, the release of the installer is the decomposition of the installer and the extraction of components configured in the corresponding patch file rather than the execution of the installer. Generally, the installer is a main component having the extension “*.exe,” and the component decomposition module 12 releases the installer and extracts the subcomponents configured in the main component.

Meanwhile, when a specific component of the component decomposition module 12 cannot be recognized as an installer in the patch file, it is subsequently detected whether the patch file is a compressed file in step S14. When it is determined as a result of the detection that the patch file is a compressed file, the compressed file is released in step S15.

When neither the installer nor the compressed file is recognized in the patch file, the component decomposition module 12 executes a sandbox process for the virtual execution of the patch file. In the sandbox process, the component decomposition module 12 activates a sandbox mode, copies the patch file to a sandbox in step S16, and executes the patch file in the sandbox mode through the execution of a dedicated script in step S17. The component decomposition module 12 of the present invention automatically executes the patch file in the sandbox mode by using a mouse macro script.

As described above, when neither the installer nor the compressed file is recognized and the overall installation file for the terminal C cannot be extracted, the component decomposition module 12 of the present invention performs the process of installing the actual patch file in a sandbox (a virtual environment). Generally, in order to install software on a computer, an operator needs to directly click a corresponding menu with a mouse according to the procedure. However, a patch file installation process in the sandbox environment is performed in an environment isolated from the outside, so that the installation process needs to be executed without the operator's manipulation. To this end, the component decomposition module 12 executes a mouse macro script to cause a mouse click effect to occur in accordance with the installation process.

Next, the component decomposition module 12 continuously tracks the process of installing the patch file installed in the sandbox mode and checks a full installed component list in step S18. Ultimately, the component decomposition module 12 may extract, identify, and list the components configured in the patch file.

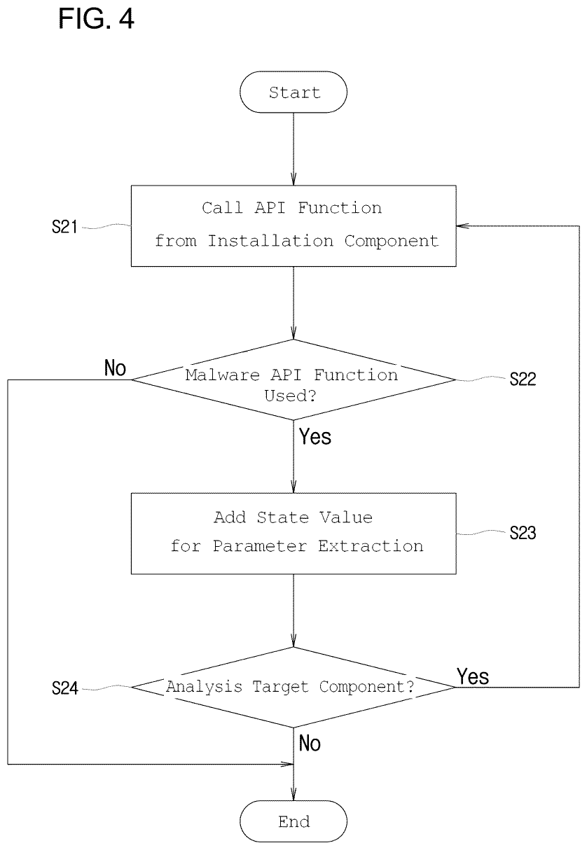

FIG. 4 is a flowchart specifically illustrating the component analysis step shown in FIG. 2.

Referring to FIGS. 1 to 3, the component analysis step S20 in the component detection method according to the present invention includes an API function calling step S21, a step S22 of checking whether to execute an API function activated when malware is executed, a state value addition step S23, and a step S24 of checking whether a component in question is an analysis target component.

More specifically, as for the component analysis step S20, the API information extraction module 13 extracts a calling target API function from among the components extracted by the component decomposition module 12 in step S21. During extraction, the API information extraction module 13 checks whether a function in question is an API function (hereinafter referred to as the ‘monitoring target API function’) activated when malware is executed through the additional setting of a state value, and, when a monitoring target API function is not identified, terminates the component analysis process at step S22. Furthermore, the number of calls to the API function is checked to check whether the number of calls to the main API function is equal to or larger than a reference value. When the monitoring target API function is identified or the number of calls to a specific API function is determined to be equal to or larger than the reference value, the API information extraction module 13 sets an IDA state value to extract the parameters of the corresponding API function in step S23. The API information extraction module 13 continuously analyzes other execution components configured in the patch file to identify the extraction of a monitoring target API function, and, when other execution components are not identified, terminates the process of identifying a monitoring target API function and setting an IDA state value for parameter extraction in step S24.

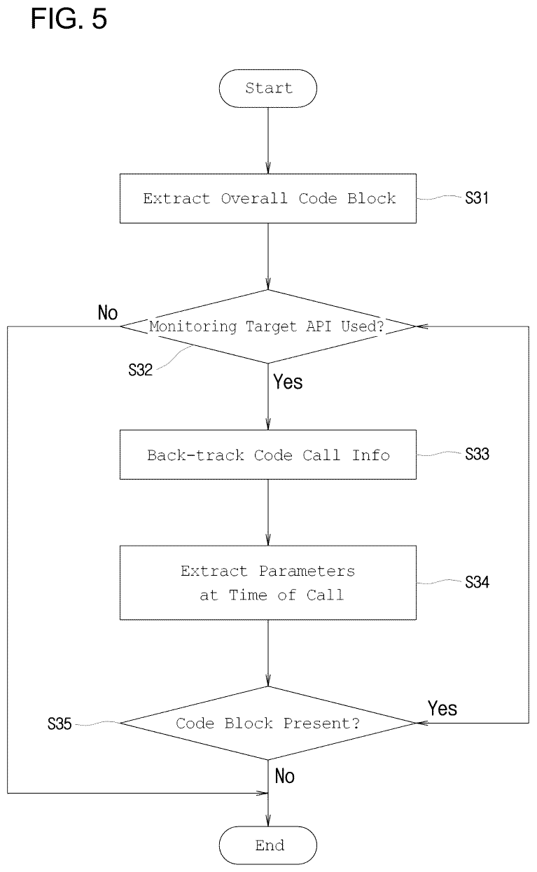

FIG. 5 is a flowchart specifically illustrating the parameter extraction analysis step shown in FIG. 2.

Referring to FIGS. 1, 2, 4, and 5, the parameter extraction step S30 in the component detection method according to the present invention includes an overall code block extraction step S31, a monitoring target main API function execution checking step S32, a code call information back-tracking step S33, a call time parameter extraction step S34, and a code block presence checking step S35.

More specifically, as for the parameter extraction step S30, the API information extraction module 13 analyzes the monitoring target API function extracted in the component analysis step S20 to extract a code block in step S31. Among all the API functions configured in the component of the patch file, a parameter extraction target API function is a monitoring target API function. Next, the API information extraction module 13 checks whether a function in question is the monitoring target API function identified through the additional setting of a state value, and, when the target API function is not identified, terminates the parameter extraction process in step S32. However, when it is identified as the monitoring target API function, the API information extraction module 13 back-tracks the code call information of the code block to extract parameters at the time when a call is made in step S33, and includes information about the parameters in subsequent component information corresponding to an analysis report and records and stores it in the reference information DB 11 in step S34. In the present embodiment, the subsequent component information is separated and stored for each piece of related software.

Thereafter, the API information extraction module 13 repeatedly extracts parameters until there is no code block, to be additionally analyzed, in the monitoring target API function in step S35.

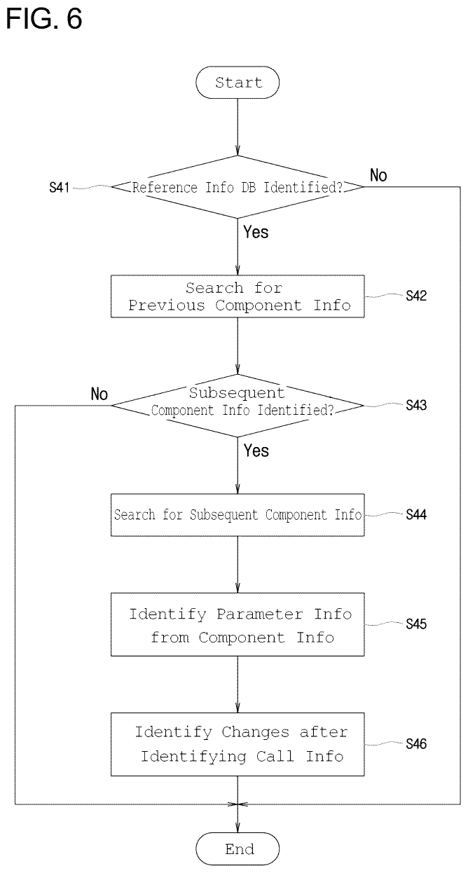

FIG. 6 is a flowchart specifically illustrating the parameter comparison step shown in FIG. 2.

Referring to FIGS. 1, 2, 5 and 6, the parameter comparison step S40 in the component detection method according to the present invention includes a reference information DB identification step S41, a previous component information search step S42, a subsequent component information identification step S43, a subsequent component information search step S44, a parameter information identification step S45, and a change identification step S46.

More specifically, as for the parameter comparison step S40, the reference information DB identification step S41 checks whether the previous component information, which is an analysis report that is stored as reference information, has been searched. As described above, component information regarding the type of API function suspected of being a threat and designated as a monitoring target among the API functions of the components configured in a previous version patch file, the number of calls, and all the parameters (the call arguments) of the API function called at the time when the API function is called is stored as the previous component information, and the previous component information is designated as reference information. When an order to compare the subsequent component information with the reference information is not entered, the parameter comparison process is terminated.

In the previous component information search step S42, the comparison/analysis module 14 identifies corresponding software to search for the previous component information, which is reference information, and searches for reference information of the same type in the reference information DB 11.

The subsequent component information identification step S43 checks whether the subsequent component information, which is an analysis report corresponding to the reference information, has been searched. When an order to search for the subsequent component information has not been entered for comparison with the reference information, the parameter comparison process is terminated.

In the subsequent component information search step S44, the comparison/analysis module 14 identifies corresponding software in order to search for the subsequent component information search, and searches for subsequent component information of the same type in the reference information DB 11.

In the parameter information identification step S45, the comparison/analysis module 14 checks parameter information in each of the reference information (the previous component information) and the subsequent component information. The parameter information may be the parameter information of all API functions configured in the component, or may be the parameter information of an API function designated as a monitoring target. In the present embodiment, the parameter information is the parameter information of the monitoring target API function.

In the change identification step S46, the comparison/analysis module 14 checks whether parameters have changed on the basis of the code call information of a code block for each API function. In this case, the code call information may be the number of calls for each API function and the parameters (the call arguments) at the time when an API function is called. When the code call information of the reference information and the code call information of the subsequent component information are different (changed), the comparison/analysis module 14 may store changes as change values, or may store only items, suspected of being dangerous among the changes, as change values.

In addition, the comparison/analysis module 14 is connected to the provider server S over a communication medium such as a cloud, and transmits the change values, which are the results of the mutual comparison between the previous component information and the subsequent component information.

Although the present invention has been described with reference to preferred embodiments of the present invention in the detailed description of the present invention described above, it will be understood by those skilled in the art or those having ordinary skill in the art that various modifications and changes to the present invention may be made without departing from the spirit and technical scope of the present invention set forth in the claims to be described later.

1. A system for detecting threat factors by comparing/analyzing installation files on the basis of SBOMs from a consumer's perspective, the system comprising:
a reference information DB configured to store Software Bill of Materials (SBOM) information, regarding types of API functions for execution of an installation file installed on a client terminal and parameters of each API function at the time when the corresponding API function is called, as previous component information, and to store SBOM information, regarding types of API functions for execution of a checking target installation file and parameters of each API function at the time when the corresponding API function is called, as subsequent component information;
a component decomposition module configured to extract components of an installation file input to the client terminal;
an API information extraction module configured to identify API functions for SBOM extraction of the components, to identify a monitoring target API function called when malware is executed by setting a state value for the API functions, to extract a code block of the monitoring target API function through operation in conjunction with a disassembler, to back-track code call information for the code block of the monitoring target API function to identify parameters at the time when the API function is called, and to generate SBOM information regarding a type of API function for which the above parameters have been identified and the parameters as subsequent component information and store it in the reference information DB; and
a comparison/analysis module configured to check whether the subsequent component information generated by the API information extraction module and previous component information of the corresponding API function match each other by comparing them.

2. The system of claim 1, wherein, when the component decomposition module cannot recognize an installer and an compressed file in the installation file in which at least one selected from the installer and the compressed file is configured, it activates a sandbox, executes the installation file by using a mouse macro script, and identifies a component installed in a sandbox mode.

3. The system of claim 1, wherein:
the previous component information and the subsequent component information each include a number of calls for each API function; and
when the API information extraction module determines that a number of calls for an API function is equal to or larger than a reference value, it designates the corresponding API function as a monitoring target API function;

4. The system of claim 1, wherein the comparison/analysis module designates changes between the previous component information and the subsequent component information as change values, and transmits the change values to a provider server.
